(19) United States
(12) Patent Application Publication
(10) Pub. No.: US 2026/0158686 A1
(43) Pub. Date: Jun. 11, 2026

(54) HAIR REMOVAL DEVICE BLADE, AND HAIR REMOVAL DEVICE PROVIDED WITH HAIR REMOVAL DEVICE BLADE

(71) Applicant: Panasonic Intellectual Property Management Co., Ltd., Osaka (JP)

(72) Inventors: AYA SAIKI, Shiga (JP); TAKASHI YAMAGUCHI, Shiga (JP); HIDEKAZU SUEYOSHI, Shiga (JP)

(21) Appl. No.: 19/105,363

(22) PCT Filed: Aug. 29, 2023
(86) PCT No.: PCT/JP2023/031167

§ 371 Date: Nov. 20, 2025

(30) Foreign Application Priority Data
Sep. 1, 2022 (JP) 2022-138971

(51) Int. Cl. B26B 19/06; B26B 19/28; B26B 19/38

(52) U.S. Cl. CPC B26B 19/06; B26B 19/28; B26B 19/3846; B26B 19/386; B26B 19/3886

(57) ABSTRACT

Hair removal device blade (1b) includes movable blade comb (452), movable blade groove (453), fixed blade comb (462), and fixed blade groove (463). Fixed blade comb (462) is disposed in a state where distal end (465a) protrudes more than distal end (455a) of movable blade comb (452). Fixed blade comb (462) has sliding contact surface (462a) that comes into sliding contact with movable blade comb (452), and skin contact surface (462b) that is opposite to sliding contact surface (462a) and can come into contact with skin S. Fixed blade comb (462) has cutting region (466) where hair (H) can be cut with fixed blade comb (462) and movable blade comb (452), and blade width (W1) of distal end portion (465) of fixed blade comb (462) is larger than groove width (W2) of a portion facing cutting region (466) in fixed blade groove (463). Then, blade pitch (P1) of fixed blade comb (462) is larger than blade pitch (P2) of movable blade comb (452).

### TECHNICAL FIELD

The present disclosure relates to a hair removal device blade and a hair removal device provided with the hair removal device blade.

### BACKGROUND ART

Conventionally, as disclosed in PTLs 1 and 2 below, there has been proposed a blade of a hair clipper (hair removal device) for cutting hair by reciprocating and sliding a comb-shaped movable blade having a movable blade comb and a movable blade groove, with respect to a comb-shaped fixed blade having a fixed blade comb and a fixed blade groove.

In PTL 1, a distance between distal end sides of adjacent fixed blades is made narrower toward the distal end, while a distance between adjacent movable blades is made wider toward the distal end. In this way, an escape prevention portion that prevents escape of hair introduced into a groove is provided on the distal end side of the fixed blade, so that hair introducing property is improved and hair cutting efficiency is improved.

Further, in PTL 2, an angle of a blade on a sliding contact surface between the fixed blade and the movable blade is set to an acute angle. In this way, a load applied to the movable blade is reduced, and hair cutting efficiency is enhanced.

### CITATION LIST

### Patent Literatures

PTL 1: Unexamined Japanese Patent Publication No. 2010-004991.

PTL 2: Unexamined Japanese Patent Publication No. 2010-119790.

### SUMMARY OF THE INVENTION

In a case of using the hair removal device blade as described in the conventional technique, it is preferable to reduce stimulation given to skin and to use the hair removal device blade more safely. At this time, it is preferable to suppress lowering in hair cutting efficiency.

In view of the above, an object of the present disclosure is to obtain a hair removal device blade and a hair removal device including the hair removal device blade that can be used more safely while suppressing lowering in hair cutting efficiency.

A hair removal device blade according to one aspect of the present disclosure includes a fixed blade and a movable blade that reciprocates and slides with respect to the fixed blade. The fixed blade includes a plurality of fixed blade combs disposed side by side at a first blade pitch in a reciprocating sliding direction of the movable blade with respect to the fixed blade, and a plurality of fixed blade grooves each disposed between a corresponding pair of adjacent fixed blade combs among the plurality of fixed blade combs in the reciprocating sliding direction. The movable blade includes a plurality of movable blade combs disposed side by side at a second blade pitch in the reciprocating sliding direction, and a plurality of movable blade grooves each disposed between a corresponding pair of adjacent movable blade combs among the plurality of movable blade combs in the reciprocating sliding direction. A fixed blade comb among the plurality of fixed blade combs and a movable blade comb among the plurality of movable blade combs are disposed so as to overlap each other so as to be in sliding contact with each other in a state where a distal end of the fixed blade comb protrudes more than a distal end of the movable blade comb. The fixed blade comb has a sliding contact surface that comes into sliding contact with the movable blade comb, and a skin contact surface that is opposite to the sliding contact surface and can come into contact with skin. The fixed blade comb has a cutting region where hair can be cut with the fixed blade comb and the movable blade comb, blade width of a distal end portion of the fixed blade comb is larger than a groove width of a portion facing the cutting region in the fixed blade groove, and the first blade pitch is larger than the second blade pitch.

Further, a hair removal device according to one aspect of the present disclosure includes a hair removal device blade, and a hair removal device body that holds the hair removal device blade in a state where a distal end of a fixed blade comb and a distal end of a movable blade comb are exposed to the outside.

According to the present disclosure, it is possible to obtain a hair removal device blade and a hair removal device including the hair removal device blade that can be used more safely while suppressing lowering in hair cutting efficiency.

### BRIEF DESCRIPTION OF THE DRAWINGS

FIG. 1 is a front view illustrating an example of a hair removal device according to an exemplary embodiment.

FIG. 2 is a sectional view taken along line A-A of FIG. 1.

FIG. 3 is a front view illustrating a main body according to the exemplary embodiment.

FIG. 4 is a sectional view taken along line B-B in FIG. 3.

FIG. 5 is a front view illustrating a head part according to the exemplary embodiment.

FIG. 6 is a view illustrating the head part according to the exemplary embodiment, and is a front view illustrating the head part in a state where a front housing is removed.

FIG. 7 is a view illustrating the head part according to the exemplary embodiment, and is an exploded perspective view illustrating the head part in a state where the front housing is removed.

FIG. 8 is an enlarged cross-sectional view illustrating an upper portion of the head part according to the exemplary embodiment.

FIG. 9 is a perspective view illustrating a fixed blade comb and a movable blade comb according to the exemplary embodiment.

FIG. 10 is a cross-sectional view illustrating the fixed blade comb and the movable blade comb according to the exemplary embodiment.

FIG. 11 is a cross-sectional view illustrating an example of a method of using the hair removal device according to the exemplary embodiment.

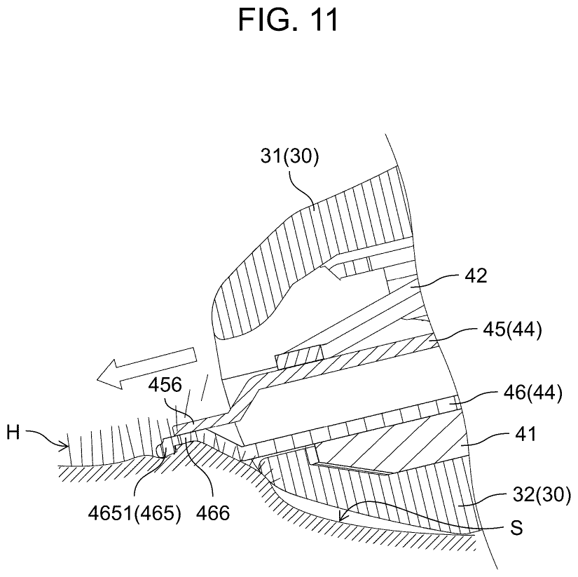

FIG. 12 is a front view schematically illustrating an example of another head part in a case where the hair removal device according to the exemplary embodiment is used as a part of a personal care kit.

FIG. 13 is a cross-sectional view taken along line C-C in FIG. 12.

### DESCRIPTION OF EMBODIMENT

Exemplary embodiment is described below in detail with reference to the drawings. However, unnecessarily detailed description may be omitted. For example, detailed descriptions of already well-known matters and redundant descriptions of substantially the same configurations may be omitted.

Note that the attached drawings and description below are provided for those skilled in the art to fully understand the present disclosure, and are not intended to limit the subject matter as described in the appended claims.

Further, in the exemplary embodiment below, as a hair removal device, a trimmer (electric hair-cutting device) to cut hair or body hair of a human or an animal is exemplified.

Here, in the present exemplary embodiment, a longitudinal direction of a base part of a trimmer is defined as up-down direction Z, a width direction of the base part of the trimmer is defined as width direction Y, and a direction orthogonal to up-down direction Z and width direction Y is defined as front-back direction X.

Further, in the present exemplary embodiment, an up-down direction of the trimmer is defined in a state where a head part is disposed on an upper side of the base part, and a side on which a distal end of the curved head part (hair removal device body) faces is defined as the front in the front-back direction.

Furthermore, in the present exemplary embodiment, a direction in which a fixed blade and a movable blade overlap each other is defined as thickness direction W.

### Exemplary Embodiment

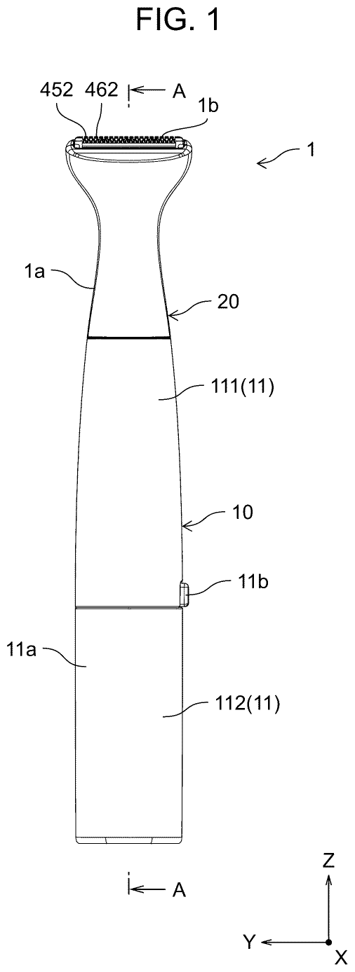

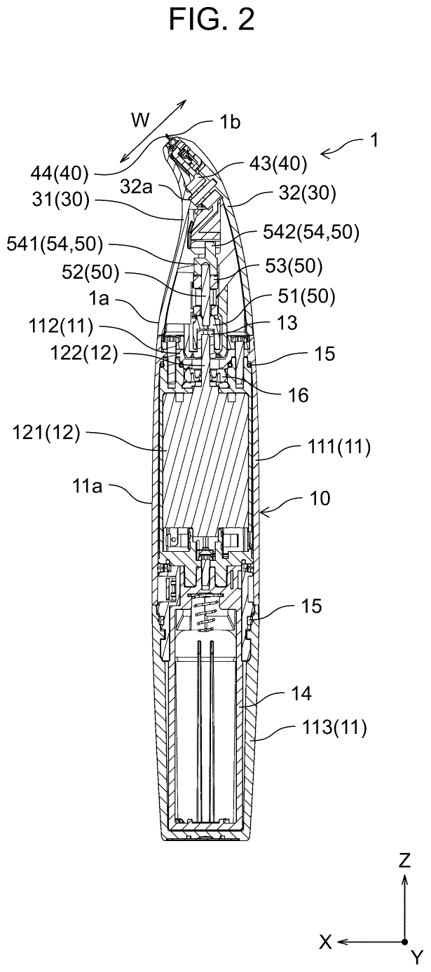

As illustrated in FIGS. 1 and 2, trimmer (hair removal device) 1 according to the present exemplary embodiment includes hair removal device body la and hair removal device blade 1b held by hair removal device body 1a. In the present exemplary embodiment, hair removal device blade 1b includes fixed blade comb 462 and movable blade comb 452 in sliding contact with fixed blade comb 462. Then, in a state where fixed blade comb 462 and movable blade comb 452 are exposed to the outside, hair removal device blade 1b is held by hair removal device body 1a. This trimmer 1 is, for example, a device that cuts body hair (hair H) of a user or the like to a desired length to treat or trim the body hair of the user or the like.

Further, in the present exemplary embodiment, trimmer 1 includes base part 10 and head part 20 detachably attached to base part 10. Then, hair removal device blade 1b is held in head housing 30 of head part 20 in a state where fixed blade comb 462 and movable blade comb 452 are exposed to the outside from an upper end.

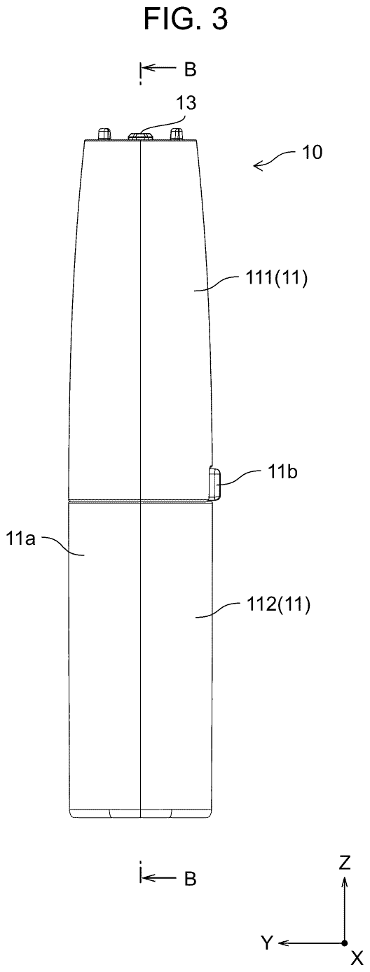

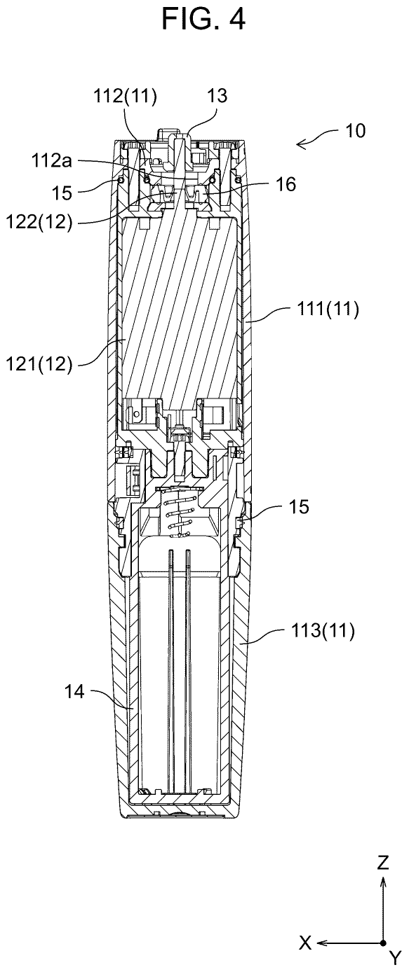

Next, a schematic configuration of base part 10 will be described with reference to FIGS. 3 and 4.

As illustrated in FIGS. 3 and 4, base part 10 has a substantially columnar shape elongated in up-down direction Z, and includes housing 11 constituting an outer frame.

This housing 11 is formed in such a size that the user can grip with one hand, and the user can grip and use housing 11 when using trimmer 1. As described above, grip 11a that can be gripped by a user's hand is formed on housing 11. This housing 11 may be formed using, for example, an insulating synthetic resin material.

Further, in the present exemplary embodiment, housing 11 is formed by joining a plurality of divided bodies, and a cavity is formed inside housing 11 formed by joining divided bodies. Then, various electric components are housed in the cavity.

Specifically, housing 11 includes cylindrical wall 111, which is substantially cylindrical and penetrating in the up-down direction, upper lid 112 disposed to cover an upper opening of cylindrical wall 111, and battery cover 113 disposed to cover a lower opening of cylindrical wall 111.

Then, a cavity formed inside housing 11 incorporates rotary motor 12, a battery (not illustrated) that supplies power to rotary motor 12, battery base 14 that holds the battery, a control board (not illustrated) that controls on and off of a power supply (on and off of driving of rotary motor 12), and the like.

In the present exemplary embodiment, rotary motor 12 is incorporated in an upper portion (in cylindrical wall 111) of housing 11, and battery base 14 is incorporated in a lower portion (in battery cover 113) of housing 11. At this time, in the present exemplary embodiment, rotary motor 12 and battery base 14 are incorporated in housing 11 in a state where battery base 14 is aligned below rotary motor 12 and has a longitudinal direction substantially coinciding with up-down direction Z. When rotary motor 12 and battery base 14 are disposed so as to be aligned in the up-down direction as described above, base part 10 (housing 11) can be made compact in a radial direction.

Further, in the present exemplary embodiment, battery cover 113 is detachably attached to cylindrical wall 111, and battery base 14 is exposed to the outside as battery cover 113 is detached from cylindrical wall 111. Then, battery base 14 is exposed to the outside so that the battery can be held on battery base 14 or the battery can be removed from battery base 14. As the battery held by such battery base 14, for example, a dry battery, a rechargeable battery, or the like can be used.

Note that, rotary motor 12 includes rotary motor body 121 and rotary motor shaft 122, and is incorporated in a cavity of housing 11 in a state where rotary motor shaft 122 protrudes upward further than rotary motor body 121. That is, rotary motor 12 is incorporated in a cavity of housing 11 in a state where a rotation axis direction substantially coincides with up-down direction Z. Then, drive shaft 13 is attached to rotary motor shaft 122 protruding upward.

Further, push-type power switch 11b that switches on and off of a power supply (on and off of driving of rotary motor 12) is formed at a lower end portion in up-down direction Z of a side portion of cylindrical wall 111. Note that, in the present exemplary embodiment, push-type power switch 11b is exemplified as a power switch, but other switches including a sliding type may be used as long as the switch is capable of turning on and off a power supply.

Note that, in the present exemplary embodiment, upper lid 112 and battery cover 113 are attached to cylindrical wall 111 with a gap sealed by packing 15.

Further, through-hole 112a is formed at a position corresponding to drive shaft 13 in upper lid 112, and rotary motor 12 is held by upper lid 112 in a state where drive shaft 13 attached to rotary motor shaft 122 is inserted into through-hole 112a. That is, in the present exemplary embodiment, drive shaft 13 is exposed to the outside of housing 11. At this time, rotary motor 12 is held by upper lid 112 in a state where a gap between rotary motor shaft 122 and through-hole 112a is sealed by waterproof rubber 16. In this way, trimmer 1 can be used even in a bathroom or the like.

Then, when head part 20 is attached to base part 10, power transmission unit (coupling) 51 described later provided in head part 20 is attached to drive shaft 13.

Note that drive shaft 13 may have a regular hexagonal shape (polygonal shape) in planar view of base part 10 (in a state where base part 10 is viewed from above in up-down direction Z), for example. As described above, when a shape of drive shaft 13 is set to a regular hexagonal shape (polygonal shape), power transmission unit (coupling) 51 can be attached to drive shaft 13 in a state where idling is suppressed. Drive shaft 13 and power transmission unit (coupling) 51 only need to be attached in a state where idling is suppressed, and are not limited to a polygonal shape. For example, a drive shaft having a D-cut structure can be used. Further, idling may also be suppressed by using a means for increasing frictional force between drive shaft 13 and power transmission unit (coupling) 51.

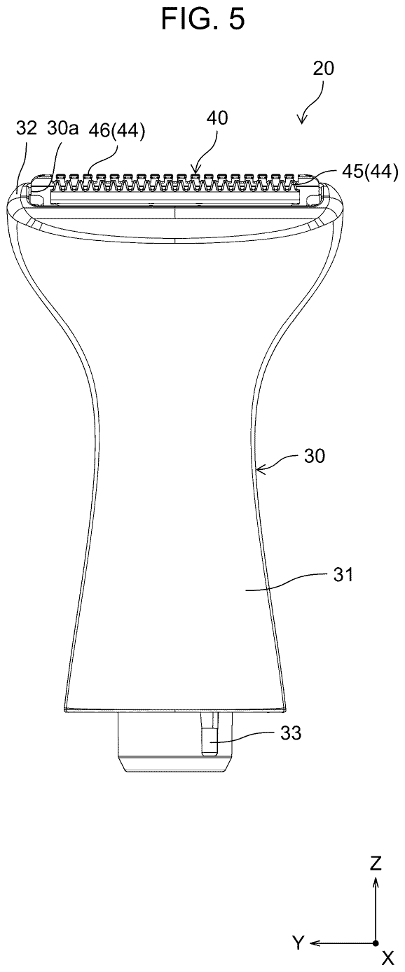

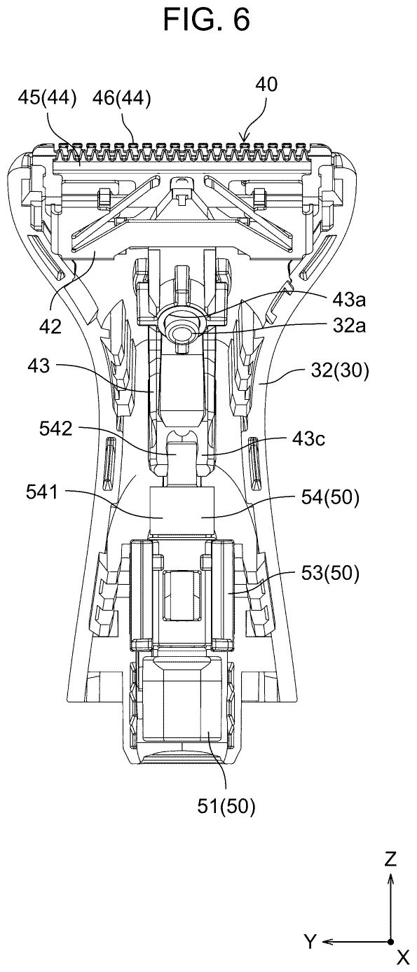

Next, a schematic configuration of head part 20 will be described with reference to FIGS. 5 and 6.

As illustrated in FIGS. 5 and 6, head part 20 includes head housing 30 detachably attached to an upper end of base part 10, and blade unit 40 held by head housing 30.

Furthermore, head part 20 includes eccentric cam block 50 as a power transmission mechanism that transmits power of drive shaft 13 of base part 10 to blade unit 40.

Head housing 30 may be formed using, for example, an insulating synthetic resin material. Further, head housing 30 is formed by joining a plurality of divided bodies, and a cavity is formed inside head housing 30 formed by joining the divided bodies. Then, blade unit 40 and eccentric cam block 50 are housed in the cavity.

Specifically, head housing 30 includes front housing 31 and rear housing 32, and head housing 30 having a cavity in the inside is formed by joining front housing 31 and rear housing 32. Then, blade unit 40 is incorporated in an upper portion in the cavity of head housing 30, and eccentric cam block 50 is incorporated in a lower portion.

Eccentric cam block 50 includes power transmission unit (coupling) 51 and operation shaft 52 attached to an upper portion of power transmission unit (coupling) 51 to operate. Eccentric cam block 50 further includes bush 53 attached to head housing 30 in a state where operation shaft 52 is fitted, and eccentric cam 54 connected to an upper end of operation shaft 52.

In the present exemplary embodiment, eccentric cam block 50 is held by head housing 30 in a state where power transmission unit (coupling) 51 protrudes downward. Furthermore, in the present exemplary embodiment, attachment part 33 for detachably attaching head part 20 to base part 10 is formed in power transmission unit (coupling) 51. Then, when head part 20 is attached to base part 10 by attachment part 33, power transmission unit (coupling) 51 and drive shaft 13 are connected in a state where idling is suppressed.

Specifically, inside power transmission unit (coupling) 51, a space having a regular hexagonal shape (polygonal shape) is formed to open downward as viewed from a back surface of head part 20 (in a state where head part 20 is viewed from a lower side in up-down direction Z). This space having a regular hexagonal shape (polygonal shape) is formed to have substantially the same size as an outer diameter of drive shaft 13, and when head part 20 is attached to base part 10, drive shaft 13 is inserted into this space having a regular hexagonal shape (polygonal shape). In this manner, when rotary motor 12 is driven, power transmission unit (coupling) 51 also rotates with rotation of drive shaft 13.

Operation shaft 52 is connected to power transmission unit (coupling) 51 in a state where idling is suppressed, and rotates together with power transmission unit (coupling) 51 that rotates by power (rotation) of rotary motor 12 transmitted from drive shaft 13.

Eccentric cam 54 includes cam body 541 connected to an upper end of operation shaft 52 in a state where idling is suppressed, and eccentric shaft 542 integrally formed at a position deviated from a rotation center of cam body 541 in an upper portion of cam body 541. Then, eccentric cam 54 also rotates in conjunction with rotation of operation shaft 52.

As described above, in the present exemplary embodiment, head part 20 includes power transmission unit (coupling) 51, and includes eccentric cam block (power transmission mechanism) 50 capable of transmitting power (rotation) of rotary motor 12. Then, eccentric cam 54 of eccentric cam block 50 is connected to blade unit 40.

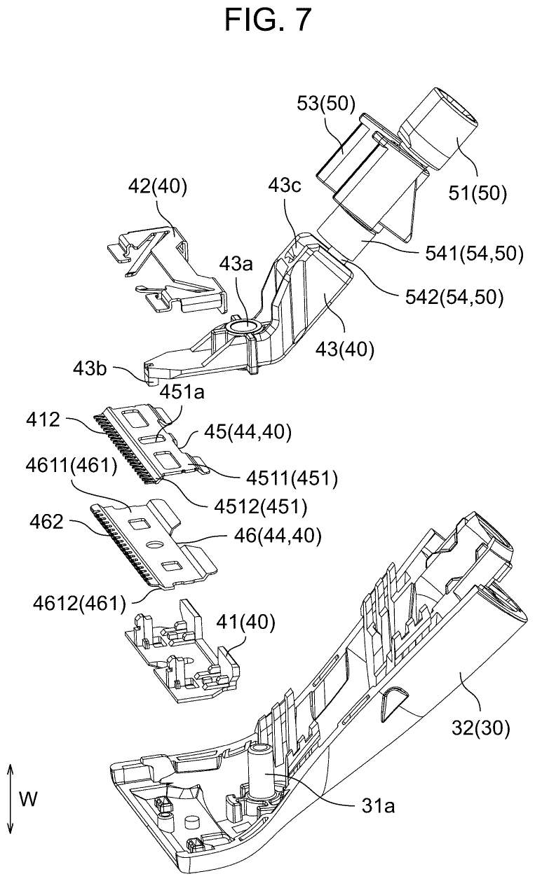

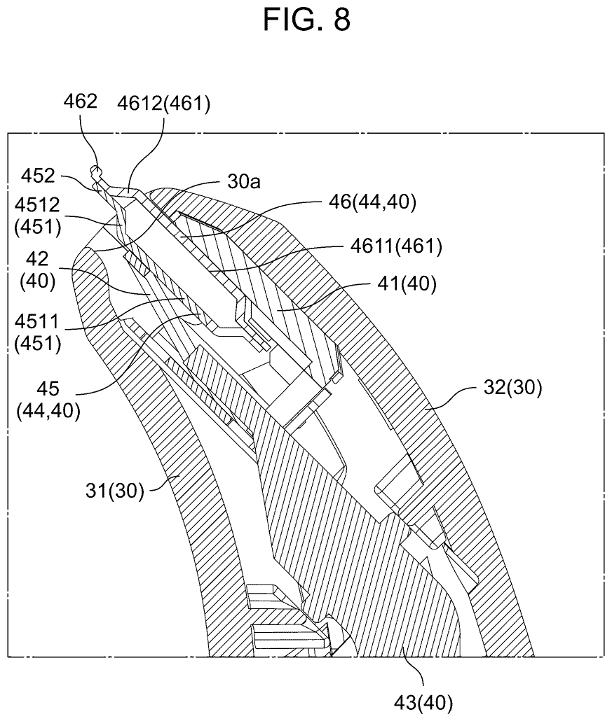

Blade unit 40 has a function of cutting hair H, and includes, as illustrated in FIGS. 7 and 8, blade part (hair removal device blade 1b) 44 formed by disposing movable plate (movable blade) 45 and fixed plate (fixed blade) 46 in a manner facing each other. Blade part 44 is configured such that movable blade comb 452 of movable plate 45 reciprocates and slides in width direction Y with respect to fixed blade comb 462 of fixed plate 46. As described above, in the present exemplary embodiment, blade part 44 of blade unit 40 corresponds to hair removal device blade 1b, and head part 20 and base part 10 other than blade part 44 correspond to hair removal device body 1a.

Movable plate 45 includes main body 451, and a plurality of movable blade combs 452 are disposed side by side at substantially equal intervals (second blade pitch P2) in a state of being separated in width direction Y at a distal end of main body 451. Then, movable blade groove 453 is formed between movable blade combs 452 adjacent to each other in width direction Y.

Similarly, fixed plate 46 also includes main body 461, and a plurality of fixed blade combs 462 are disposed side by side at substantially equal intervals (first blade pitch P1) in a state of being separated in width direction Y at a distal end of main body 461. Then, fixed blade groove 463 is formed between fixed blade combs 462 adjacent to each other in width direction Y.

As illustrated in FIG. 7, blade unit 40 further includes base part 41 made from synthetic resin on which fixed plate 46 is disposed, and pressing spring 42 that presses movable plate 45 to fixed plate 46 side. Further, blade unit 40 includes driver 43 that is attached to movable plate 45 and causes movable blade comb 452 of movable plate 45 to reciprocate and slide in width direction Y with respect to fixed blade comb 462 of fixed plate 46.

In the present exemplary embodiment, as illustrated in FIG. 7, through-hole 43a penetrating in thickness direction W is formed in driver 43. Then, by inserting protrusion 32a of rear housing 32 into through-hole 43a, driver 43 is attached to rear housing 32 so as to be swingable in width direction Y about protrusion 32a. Further, shaft housing 43c in which eccentric shaft 542 of eccentric cam 54 is housed is formed in driver 43, and by rotating eccentric shaft 542 housed in shaft housing 43c, driver 43 swings in width direction Y about protrusion 32a. Then, protrusion 43b formed on driver 43 is engaged with engagement hole 451a formed in main body 451 of movable plate 45, so that movable plate 45 reciprocates in width direction Y in conjunction with swinging of driver 43.

As described above, in the present exemplary embodiment, rotary motion transmitted from drive shaft 13 to eccentric cam block 50 is converted into reciprocating motion in width direction Y by driver 43, and reciprocating motion in width direction Y of driver 43 is transmitted to movable plate 45. Then, movable plate 45 reciprocates in width direction Y in a state of being pressed to fixed plate 46 side by pressing spring 42, so that movable blade comb 452 comes into sliding contact with a front surface (sliding contact surface 462a) of fixed blade comb 462. In the present exemplary embodiment, movable blade comb 452 reciprocates and slides in a state of being brought into planarly close contact with fixed blade comb 462.

Note that, in the present exemplary embodiment, main body 451 of movable plate 45 includes base 4511 and bent wall 4512 connected to a distal end of base 4511 so as to be bent toward fixed plate 46 side. Then, a plurality of movable blade combs 452 are formed at a distal end of bent wall 4512.

Further, main body 461 of fixed plate 46 includes a base 4611 and a bent wall 4612 connected to a distal end of base 4611 so as to be bent toward movable plate 45 side. Then, a plurality of fixed blade combs 462 are formed at a distal end of bent wall 4612.

Therefore, on a distal end side of blade part 44, only movable blade comb 452 and fixed blade comb 462 come into sliding contact with each other when movable plate 45 is reciprocated in width direction Y.

Further, in the present exemplary embodiment, slit 30a is formed at an upper end of head housing 30, and blade unit 40 is held by head housing 30 in a state where distal end 465a of fixed blade comb 462 and distal end 455a of movable blade comb 452 are exposed to the outside from slit 30a.

Furthermore, in the present exemplary embodiment, head housing 30 has a curved shape with an upper end positioned forward in front-back direction X, and distal end 465a of fixed blade comb 462 and distal end 455a of movable blade comb 452 protrude forward and upward. Further, in the present exemplary embodiment, fixed blade comb 462 and movable blade comb 452 are disposed in an overlapping manner in a state where movable blade comb 452 is located in front of fixed blade comb 462 in front-back direction X.

As described above, in the present exemplary embodiment, blade unit 40 is held on a distal end side of head housing 30, and a distal end side of head housing 30 is curved toward a side where movable blade comb 452 is located (front side in front-back direction X) between fixed blade comb 462 and movable blade comb 452. In this way, a rear surface of fixed blade comb 462 (surface opposite to a side on which movable blade comb 452 comes into sliding contact: skin contact surface 462b) can be brought into contact with skin S more easily and reliably when trimmer 1 is used.

As described above, in the present exemplary embodiment, when power switch 11b is operated to drive rotary motor 12, rotation of rotary motor 12 is transmitted to driver 43 via eccentric cam block 50, and is converted into reciprocating motion by driver 43.

Then, when driver 43 reciprocates, movable plate 45 reciprocates with respect to fixed plate 46. Then, movable blade comb 452 reciprocates and slides with respect to fixed blade comb 462, so that hair H introduced between fixed blade groove 463 and movable blade groove 453 is cut between movable blade comb 452 and fixed blade comb 462.

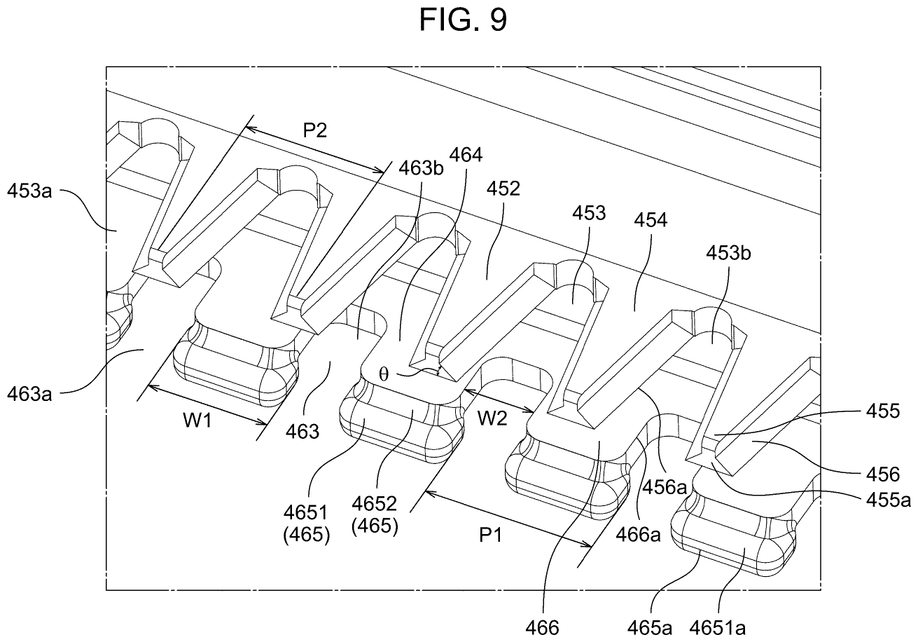

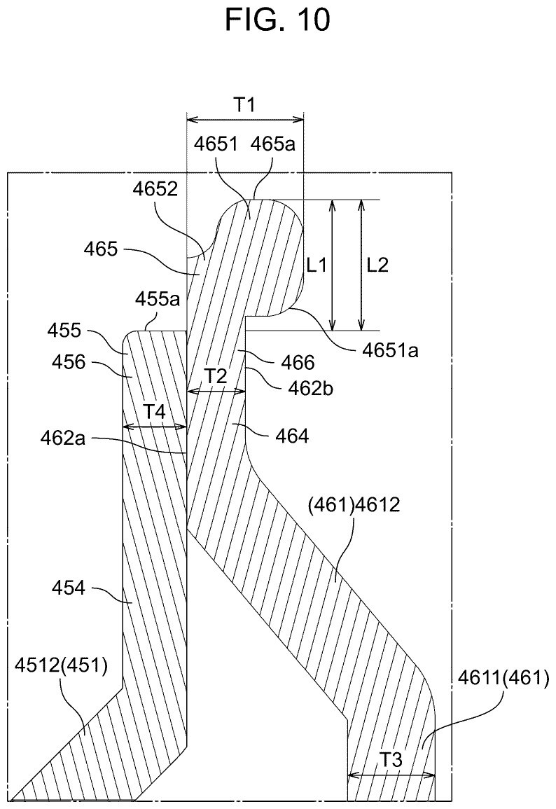

Next, a specific configuration of movable blade comb 452, fixed blade comb 462, movable blade groove 453, and fixed blade groove 463 will be described with reference to FIGS. 9 and 10.

Movable blade comb 452 is formed so as to protrude in one direction from main body 451, and includes root 454 connected to main body 451 and distal end portion 455 connected to root 454. In the present exemplary embodiment, a direction orthogonal to a direction (protruding direction) in which movable blade comb 452 protrudes is a blade moving direction (reciprocating sliding direction of a movable blade: width direction Y).

Similarly, fixed blade comb 462 is also formed so as to protrude in one direction from main body 461, and includes root 464 connected to main body 461 and distal end portion 465 connected to root 464. In the present exemplary embodiment, when movable plate 45 and fixed plate 46 are overlapped with each other, movable blade comb 452 and fixed blade comb 462 protrude in the same direction. Therefore, in an assembled state of blade unit 40, a direction in which fixed blade comb 462 protrudes (protruding direction) is also a direction orthogonal to blade moving direction (reciprocating sliding direction of movable blade: width direction Y).

Furthermore, in the present exemplary embodiment, fixed blade comb 462 and movable blade comb 452 are disposed to overlap each other so as to be in sliding contact with each other in a state where distal end 465a of fixed blade comb 462 protrudes more than distal end 455a of movable blade comb 452. Then, hair H is cut in a state where a rear surface (surface on an opposite side to sliding contact surface 462a with which movable blade comb 452 is in sliding contact: skin contact surface 462b) of distal end portion 465 of fixed blade comb 462 protruding more than distal end 455a of movable blade comb 452 is brought into contact with skin S. This configuration prevents movable blade comb 452 from coming into direct contact with skin S during use of trimmer 1.

Further, movable blade comb 452 has movable side hair cutting region 456 where hair H can be cut together with fixed blade comb 462. In the present exemplary embodiment, a region facing fixed blade groove 463 in distal end portion 455 of movable blade comb 452 is movable side hair cutting region 456. Then, both sides in width direction Y of movable side hair cutting region 456 are cut portions 456a capable of cutting hair H. In the present exemplary embodiment, cut portion 456a has shape of a sharper edge, so as to be able to reliably sandwich and cut hair H. Angle θ of an edge of this cut portion 456a can be, for example, 45 degrees.

On the other hand, fixed blade comb 462 also has fixed side hair cutting region (cutting region) 466 where hair H can be cut together with movable blade comb 452. In the present exemplary embodiment, when viewed along thickness direction W, a region that can overlap movable side hair cutting region 456 is fixed side hair cutting region (cutting region) 466. Then, both sides in width direction Y of fixed side hair cutting region (cutting region) 466 are cut portions 466a capable of cutting hair H.

Further, movable blade groove 453 is formed so as to open on a distal end side in a protruding direction of movable blade comb 452, between two movable blade combs 452 adjacent to each other in width direction (reciprocating sliding direction of the movable blade) Y. That is, movable blade groove 453 has opening side 453a on a distal end side of movable blade comb 452, and depth side 453b on a root side of movable blade comb 452.

Similarly, fixed blade groove 463 is formed so as to open on a distal end side in a protruding direction of fixed blade comb 462, between two fixed blade combs 462 adjacent to each other in width direction (reciprocating sliding direction of the movable blade) Y. That is, in fixed blade groove 463, the distal end side of fixed blade comb 462 is opening side 463a, and the root side of fixed blade comb 462 is depth side 463b.

Note that, in the present exemplary embodiment, movable blade comb 452 is formed in a tapered shape that is tapered when viewed along thickness direction W. Therefore, movable blade groove 453 is formed such that groove width in width direction (reciprocating sliding direction of the movable blade) Y increases from depth side 453b toward opening side 453a.

On the other hand, fixed blade comb 462 is formed such that blade width in width direction (reciprocating sliding direction of the movable blade) Y is substantially the same as viewed along thickness direction W in fixed side hair cutting region (cutting region) 466. Accordingly, fixed blade groove 463 is formed to have substantially the same groove width in width direction (reciprocating sliding direction of movable blade) Y at a portion corresponding to fixed side hair cutting region (cutting region) 466.

Here, in the present exemplary embodiment, hair removal device blade 1b can be used more safely while lowering in cutting efficiency of hair H is suppressed.

Specifically, blade width W1 of distal end portion 465 of fixed blade comb 462 is set to be larger than groove width W2 of a portion facing fixed side hair cutting region (cutting region) 466 of fixed blade groove 463. In this way, distal end portion 465 of fixed blade comb 462 can be brought into surface contact with skin S more reliably, and a contact area of distal end portion 465 of fixed blade comb 462 with skin S can be increased. That is, a contact area of a cutting edge of the fixed blade with skin (skin surface) S can be increased when hair removal device blade 1b is used (when hair removal device blade 1b is in contact with skin S and used). Then, distal end portion 465 of fixed blade comb 462 can firmly press skin S, so that stimulation given to skin S by fixed blade comb 462 can be more reliably reduced when hair removal device blade 1b is used. At this time, a variable portion that changes a contact area of a cutting edge of the fixed blade with skin (skin surface) S may be provided, and a contact area of a cutting edge of the fixed blade with skin (skin surface) S may be adjusted according to a portion to be used.

Further, in the present exemplary embodiment, blade width W1 of distal end portion 465 of fixed blade comb 462 is set to be larger than blade width of fixed side hair cutting region (cutting region) 466. Then, both ends in width direction Y of distal end portion 465 make opening width of fixed blade groove 463 smaller than groove width W2. In this way, it is possible to prevent hair H introduced into fixed blade groove 463 from escaping from an opening of fixed blade groove 463, and it is possible to prevent cutting efficiency of hair H from being lowered.

Further, in the present exemplary embodiment, blade pitch P1 of fixed blade comb 462 is set to be larger than blade pitch P2 of movable blade comb 452. In this way, opportunities for cutting hair H introduced into fixed blade grooves 463 by movable blade comb 452 are increased, and lowering in cutting efficiency of hair H can be suppressed.

Further, in the present exemplary embodiment, thickness (thickness of cutting edge of fixed blade) T1 of distal end portion 465 of fixed blade comb 462 is set to be larger than thickness (blade thickness in blade groove portion of fixed blade groove 463 that is cut portion 466a of fixed blade comb 462) T2 of fixed side hair cutting region (cutting region) 466. Further, thickness T1 of distal end portion 465 of fixed blade comb 462 is set to be larger than thickness T3 of main body 461.

In the present exemplary embodiment, bending processing is applied to a distal end of fixed blade comb 462, and thick portion 4651 protruding to a side opposite to a side on which movable blade comb 452 comes into sliding contact is formed at distal end portion 465 of fixed blade comb 462, so that thickness T1 of distal end portion 465 is increased.

Therefore, in the present exemplary embodiment, distal end portion 465 of fixed blade comb 462 has a shape bending toward a side opposite to a side on which movable blade comb 452 is brought into sliding contact with fixed side hair cutting region (cutting region) 466. That is, in the present exemplary embodiment, distal end portion 465 of fixed blade comb 462 includes bent portion 4652 connected to fixed side hair cutting region (cutting region) 466, and thick portion 4651 connected to bent portion 4652.

Furthermore, in the present exemplary embodiment, no edge is formed on outer surface 4651a of thick portion 4651. Specifically, even in a state of being viewed from any of width direction Y, thickness direction W, and a direction orthogonal to width direction Y and thickness direction W, a contour shape of thick portion 4651 is a shape formed by a curved line protruding outward and a straight line. Such a shape can be obtained, for example, by polishing a corner portion of thick portion 4651. Note that it is also possible to prevent an edge from being formed on a cutting edge of the fixed blade by forming the entire circumference of the cutting edge of the fixed blade (distal end portion 465 of fixed blade comb 462) into a curved surface.

Then, by forming distal end portion 465 of fixed blade comb 462 in such a shape, thick portion 4651 is brought into contact with skin (skin surface) S when fixed plate (fixed blade) 46 side of blade part (hair removal device blade) 44 is brought into contact with skin (skin surface) S for use. In this way, it is possible to improve the safety at the time of use and improve the skin feel.

Note that instead of applying bending processing to a distal end of fixed blade comb 462, thickness T1 of distal end portion 465 can be increased by forging a sheet metal material.

Further, in the present exemplary embodiment, movable blade comb 452 and fixed blade comb 462 are disposed such that distal end 465a of fixed blade comb 462 protrudes further outward than distal end 455a of movable blade comb 452. Furthermore, in the present exemplary embodiment, length L1 in a protruding direction of fixed blade comb 462 of thick portion 4651 is set to be shorter than length L2 from distal end 465a of fixed blade comb 462 to distal end 455a of movable blade comb 452 (see FIG. 10).

In this manner, movable side hair cutting region 456 of movable blade comb 452 is disposed in a thin region (fixed side hair cutting region 466) of fixed blade comb 462, and hair H can be more reliably cut short.

Further, when length L1 is set to be shorter than length L2, it is possible to prevent thick portion 4651 from interfering with contact of skin contact surface 462b of fixed side hair cutting region 466 with skin S. As a result, cut hair H is prevented from remaining in a long state, and hair H can be cut short more reliably.

Note that in order to prevent thick portion 4651 from interfering with contact of skin contact surface 462b of fixed side hair cutting region 466 with skin S, length L1 needs to be shortened. However, when length L1 is shortened, strength of fixed blade comb 462 is lowered. On the other hand, when length LI is increased, strength of fixed blade comb 462 can be maintained, but hair H may not be cut short.

Therefore, in the present exemplary embodiment, length L1 is set so to length that can prevent cut hair H from remaining in a long state while suppressing lowering in strength of fixed blade comb 462. In this manner, a shape of a plurality of fixed blade combs 462 is such that a flat portion comes into contact with skin (skin surface) S when hair removal device blade 1b is used (when hair removal device blade 1b is brought into contact with skin S and used).

Note that, in the present exemplary embodiment, thickness T4 of movable side hair cutting region 456 and thickness T2 of fixed side hair cutting region 466 are made to be substantially equal.

With trimmer 1 having such a configuration, it is possible to more reliably reduce stimulation given to skin S by fixed blade comb 462, and thus, it is possible to use trimmer 1 more safely even in a case where trimmer 1 is used for a soft part of skin S.

Note that trimmer 1 may be configured to include only head part 20 described above, that is, may be a hair removal device including only one type of head part. However, trimmer 1 described in the above exemplary embodiment can also be used as one of personal care kits in which a head having various functions can be attached to common base part 10. That is, trimmer 1 may further include another head having a different function of an action part.

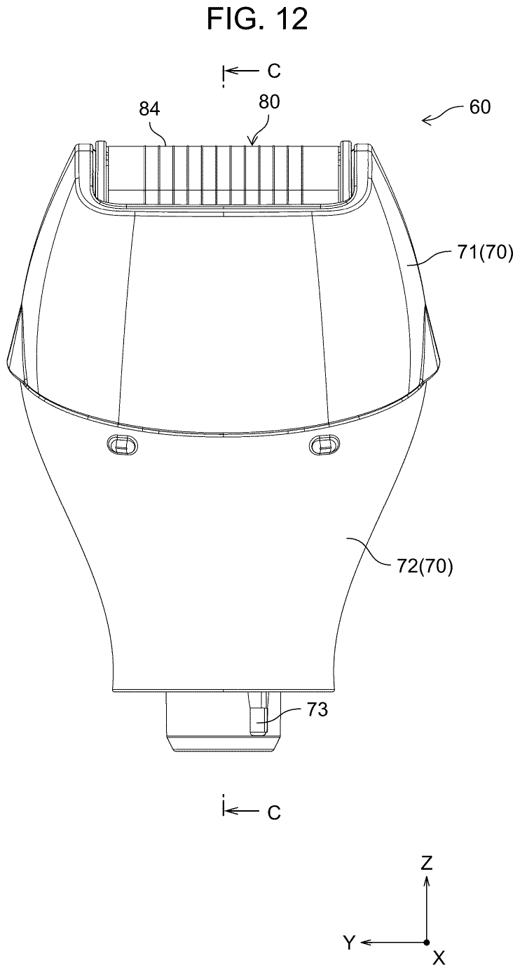

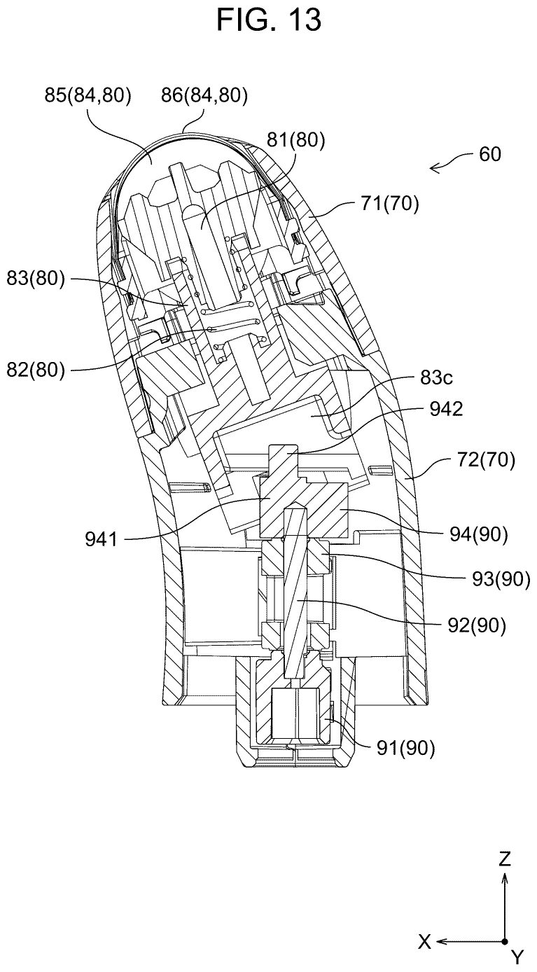

For example, in addition to head part 20, head part 60 for finishing as illustrated in FIGS. 12 and 13 may be provided. In this way, for example, after cutting hair H that is relatively long by using head part 20, hair H can be cut shorter using head part 60 for finishing.

As illustrated in FIGS. 12 and 13, head part 60 for finishing includes head housing 70 detachably attached to an upper end of base part 10, and blade unit 80 held by head housing 70. Furthermore, head part 60 for finishing includes eccentric cam block 90 as a power transmission mechanism that transmits power of drive shaft 13 of base part 10 to blade unit 80.

Head housing 70 may be formed using, for example, an insulating synthetic resin material. Further, head housing 70 is formed by joining a plurality of divided bodies, and a cavity is formed inside head housing 70 formed by joining the divided bodies. Then, blade unit 80 and eccentric cam block 90 are housed in the cavity.

Specifically, head housing 70 includes upper housing 71 and lower housing 72, and upper housing 71 and lower housing 72 are joined together to form head housing 70 having a cavity in the inside. Then, blade unit 80 is incorporated in an upper portion in the cavity of head housing 70, and eccentric cam block 90 is incorporated in a lower portion.

Eccentric cam block 90 includes power transmission unit (coupling) 91 and operation shaft 92 attached to an upper portion of power transmission unit (coupling) 91 to operate. Eccentric cam block 90 further includes bush 93 attached to head housing 70 in a state where operation shaft 92 is fitted, and eccentric cam 94 connected to an upper end of operation shaft 92.

Furthermore, attachment part 73 for detachably attaching head part 60 for finishing to base part 10 is formed on power transmission unit (coupling) 91. Further, inside power transmission unit (coupling) 91, a space having a regular hexagonal shape (polygonal shape) is formed to open downward as viewed from a back surface of head part 60 for finishing (in a state where head part 60 for finishing is viewed from a lower side in up-down direction Z).

Further, eccentric cam 94 includes cam body 941 connected to an upper end of operation shaft 92 in a state where idling is suppressed, and eccentric shaft 942 integrally formed at a position deviated from a rotation center of cam body 941 in an upper portion of cam body 941.

As described above, head part 60 for finishing includes power transmission unit (coupling) 91 and eccentric cam block (power transmission mechanism) 90 capable of transmitting power (rotation) of rotary motor 12. Then, eccentric cam 94 of eccentric cam block 90 is connected to blade unit 80.

Blade unit 80 has a function of cutting hair H, and as illustrated in FIGS. 12 and 13, blade unit 80 includes blade part 84 formed by inner blade 85 and outer blade 86. Blade part 84 is configured such that inner blade 85 reciprocates in width direction Y with respect to outer blade 86.

Blade unit 80 further includes drive shaft 81 that holds inner blade 85, and pressing spring 82 that presses inner blade 85 toward outer blade 86 side. Further, blade unit 80 includes driver 83 that is attached to inner blade 85 and causes inner blade 85 to reciprocate in width direction Y with respect to outer blade 86.

Further, shaft housing 83c in which eccentric shaft 942 of eccentric cam 94 is housed is formed in driver 83, and by rotating eccentric shaft 942 housed in shaft housing 83c, driver 83 reciprocates in width direction Y. Then, inner blade 85 attached to driver 83 reciprocate in width direction Y in conjunction with reciprocation of driver 83.

When head part 60 for finishing having such a configuration is used, and an outer surface of outer blade 86 is brought into contact with skin S, hair H of skin S can be cut shorter. At this time, as outer blade 86, a net blade having a plurality of blade holes formed in a mesh shape can be used. In this way, trimmer (hair removal device) 1 to which a net blade can be attached can be obtained. Further, trimmer (hair removal device) 1 can be configured to be attached with a skin guard so that hair removal device blade 1b does not directly touch skin S when hair removal device blade 1b is used.

### Action and Effect

Hereinafter, a characteristic configuration of the hair removal device blade and the hair removal device including the hair removal device blade shown in the exemplary embodiment described above and an effect obtained by the hair removal device blade and the hair removal device will be described.

(Technique 1) Hair removal device blade 1b described in the above exemplary embodiment includes fixed plate (fixed blade) 46 and movable plate (movable blade) 45 that reciprocates and slides with respect to fixed plate (fixed blade) 46. This hair removal device blade 1b cuts hair H with fixed plate (fixed blade) 46 and movable plate (movable blade) 45.

Here, fixed plate (fixed blade) 46 includes a plurality of fixed blade combs 462 disposed side by side at first blade pitch P1 in a reciprocating sliding direction (Y direction) of movable plate (movable blade) 45 with respect to fixed plate (fixed blade) 46. Fixed plate (fixed blade) 46 includes a plurality of fixed blade grooves 463 formed between fixed blade combs 462 adjacent to each other in the reciprocating sliding direction (Y direction).

On the other hand, movable plate (movable blade) 45 includes a plurality of movable blade combs 452 disposed side by side at second blade pitch P2 in the reciprocating sliding direction (Y direction), and a plurality of movable blade grooves 453 formed between movable blade combs 452 adjacent to each other in the reciprocating sliding direction (Y direction).

Further, fixed blade comb 462 and movable blade comb 452 are disposed to overlap each other so as to be in sliding contact with each other in a state where distal end 465a of fixed blade comb 462 protrudes more than distal end 455a of movable blade comb 452.

Furthermore, fixed blade comb 462 further has sliding contact surface 462a that comes into sliding contact with movable blade comb 452, and skin contact surface 462b that is opposite to sliding contact surface 462a and can come into contact with the skin.

Further, fixed blade comb 462 has fixed side hair cutting region (cutting region) 466 where hair H can be cut together with movable blade comb 452.

Then, blade width W1 of distal end portion 465 of fixed blade comb 462 is set to be larger than groove width W2 of a portion facing fixed side hair cutting region (cutting region) 466 of fixed blade groove 463. Blade pitch P1 of fixed blade comb 462 is larger than blade pitch P2 of movable blade comb 452.

As described above, in hair removal device blade 1b described in the above-mentioned exemplary embodiment, blade width W1 of distal end portion 465 of fixed blade comb 462 is set to be larger than groove width W2 of a portion facing fixed side hair cutting region (cutting region) 466 of fixed blade groove 463. In this way, distal end portion 465 of fixed blade comb 462 can be brought into surface contact with skin S more reliably, and a contact area of distal end portion 465 of fixed blade comb 462 with skin S can be increased. For this reason, distal end portion 465 of fixed blade comb 462 can firmly press skin S. As a result, stimulation given to skin S by fixed blade comb 462 can be more reliably reduced when hair removal device blade 1b is used, so that hair removal device blade 1b can be more safely used even in a case where fixed blade comb 462 is used for a soft part of skin S.

Furthermore, in hair removal device blade 1b described in the above exemplary embodiment, blade pitch P1 of fixed blade comb 462 is set to be larger than blade pitch P2 of movable blade comb 452. In this way, when an interval between blades of movable blade comb 452 is narrower than an interval between blades of fixed blade comb 462, it is possible to increase opportunities for cutting hair H introduced into fixed blade groove 463 by movable blade comb 452. As a result, it is possible to suppress lowering in cutting efficiency of hair H.

As described above, with the configuration of hair removal device blade 1b described in the above exemplary embodiment, it is possible to use hair removal device blade 1b more safely while suppressing lowering in cutting efficiency of hair H.

(Technique 2) In (Technique 1) above, thickness T1 of distal end portion 465 of fixed blade comb 462 may be larger than thickness T2 of fixed side hair cutting region (cutting region) 466.

As described above, when blade thickness of distal end portion 465 of fixed blade comb 462 is set to be thicker than blade thickness of fixed side hair cutting region (cutting region) 466, hair removal device blade 1b which is gentle on skin can be obtained. Furthermore, by increasing blade thickness of fixed blade comb 462 only at distal end portion 465, length of hair H cut in fixed side hair cutting region (cutting region) 466 can be prevented from becoming longer than desired length (thickness T2). In other words, by increasing blade thickness of fixed blade comb 462 only at distal end portion 465, it is possible to obtain hair removal device blade 1b which is gentle on skin while preventing distal end portion 465 from inhibiting hair H to be cut at desired length in fixed side hair cutting region (cutting region) 466.

(Technique 3) In (Technique 2) described above, fixed plate (fixed blade) 46 may include main body 461 in which a plurality of fixed blade combs 462 are connected, and thickness T1 of distal end portion 465 of fixed blade comb 462 may be larger than thickness T3 of main body 461. That is, blade thickness of distal end portion 465 of fixed blade comb 462 may be made larger than thickness of a material of the fixed plate (fixed blade) 46. In this way, hair removal device blade 1b that is gentler on skin and safer can be obtained.

(Technique 4) Further, in (Technique 3) described above, distal end portion 465 of fixed blade comb 462 may be bent toward a side opposite to a side on which movable blade comb 452 comes into sliding contact with fixed side hair cutting region (cutting region) 466.

In this way, it is possible to more easily make thickness T1 of distal end portion 465 of fixed blade comb 462 thicker than thickness T3 of main body 461.

(Technique 5) Further, in (Technique 4) described above, distal end portion 465 of fixed blade comb 462 may have thick portion 4651 protruding to a side opposite to a side on which movable blade comb 452 comes into sliding contact, and thick portion 4651 may have a shape in which an edge is not formed on outer surface 4651a.

In this way, hair removal device blade 1b that is further gentler on skin and safer can be obtained.

(Technique 6) Further, trimmer (hair removal device) 1 described in the above exemplary embodiment includes hair removal device blade 1b according to any of (Technique 1) to (Technique 5). Further, trimmer (hair removal device) 1 described in the above exemplary embodiment includes hair removal device body la that holds hair removal device blade 1b in a state where distal end 465a of fixed blade comb 462 and distal end 455a of movable blade comb 452 are exposed to the outside.

As described above, with trimmer (hair removal device) 1 described in the above exemplary embodiment, trimmer (hair removal device) 1 can be used more safely while lowering in cutting efficiency of hair H is suppressed.

(Technique 7) In (Technique 6) described above, hair removal device blade 1b may be held on a distal end side of hair removal device body 1a, and a distal end side of hair removal device body la may be curved toward the side where movable blade comb 452 is located with respect to the side where the fixed blade comb 462 is located (front side in the front-back direction).

In this way, when trimmer (hair removal device) 1 is used, skin contact surface 462b side of fixed blade comb 462 can be brought into contact with skin S more easily and reliably, and it is possible to suppress direct contact of movable blade comb 452 with skin S at the time of cutting of hair H. As a result, trimmer (hair removal device) 1 that is safer and more gentle on skin can be obtained.

### Others

The content of the hair removal device blade and the hair removal device including the hair removal device blade according to the present disclosure is described above, but it is obvious to those skilled in the art that various modifications and improvements are possible without limitation to the description of these.

For example, the present disclosure can be applied to an exemplary embodiment in which changes, replacements, additions, omissions, and the like of the configurations described in the above exemplary embodiment are made. Further, constituent elements described in the above exemplary embodiment may be combined to make a new exemplary embodiment.

For example, in the above exemplary embodiment, trimmer 1 is exemplified as the hair removal device. However, the hair removal device is not limited to trimmer 1 shown in the above exemplary embodiment, and the present disclosure can be applied to various types of hair removal devices. For example, the present disclosure can be applied to a hair clipper (trimmer).

Further, the above exemplary embodiment exemplifies the hair removal device including base part 10 and head part 20 detachably attached to base part 10. However, the hair removal device may include hair removal device body la that is integrally formed.

Further, specifications (shape, size, layout, and the like) of the head part and the grip part, and other details can be changed as appropriate.

### Industrial Applicability

As described above, the hair removal device blade and the hair removal device including the hair removal device blade according to the present disclosure are capable of, and can be used for various hair removal device blades for home use and commercial use and for hair removal devices including the hair removal device blades.

### Reference Marks in the Drawings

1 trimmer (hair removal device)
1a hair removal device body
1b hair removal device blade
44 blade part (hair removal device blade)
45 movable plate (movable blade)
452 movable blade comb
455a distal end
453 movable blade groove
46 fixed plate (fixed blade)
461 main body
462 fixed blade comb
462b skin contact surface
465a distal end
4651 thick portion
4651a outer surface
466 fixed side hair cutting region (cutting region)
463 fixed blade groove
T1 thickness of distal end portion
T2 thickness of cutting region
T3 thickness of main body
W1 blade width of distal end portion of fixed blade comb
W2 groove width of portion facing cutting region in fixed blade groove
P1 blade pitch of fixed blade comb
P2 blade pitch of movable blade comb
S skin
H hair

1. A hair removal device blade comprising:
a fixed blade; and
a movable blade that reciprocates and slides with respect to the fixed blade,
wherein the fixed blade includes a plurality of fixed blade combs disposed side by side at a first blade pitch in a reciprocating sliding direction of the movable blade with respect to the fixed blade, and a plurality of fixed blade grooves each disposed between a corresponding pair of adjacent fixed blade combs among the plurality of fixed blade combs in the reciprocating sliding direction,
the movable blade includes a plurality of movable blade combs disposed side by side at a second blade pitch in the reciprocating sliding direction, and a plurality of movable blade grooves each disposed between a corresponding pair of adjacent movable blade combs among the plurality of movable blade combs in the reciprocating sliding direction,
a fixed blade comb among the plurality of fixed blade combs and a movable blade comb among the plurality of movable blade combs are disposed in an overlapping manner so as to be in sliding contact with each other in a state where a distal end of the fixed blade comb protrudes more than a distal end of the movable blade comb,
the fixed blade comb has a sliding contact surface that comes into sliding contact with the movable blade comb, and a skin contact surface that is opposite to the sliding contact surface and is capable of coming into contact with skin,
the fixed blade comb has a cutting region where hair can be cut with the fixed blade comb and the movable blade comb,
a blade width of a distal end portion of the fixed blade comb is larger than a groove width of a portion facing the cutting region in the fixed blade groove, and
the first blade pitch is larger than the second blade pitch.

2. The hair removal device blade according to claim 1, wherein
a thickness of the distal end portion of the fixed blade comb is larger than a thickness of the cutting region.

3. The hair removal device blade according to claim 2, wherein
the fixed blade includes a main body to which the plurality of fixed blade combs are connected, and
a thickness of a distal end portion of the fixed blade comb is larger than a thickness of the main body.

4. The hair removal device blade according to claim 3, wherein
the distal end portion of the fixed blade comb has a shape bending toward a side opposite to a side where the movable blade comb is in sliding contact with the cutting region.

5. The hair removal device blade according to any one of claims 1 to 4, wherein
the distal end portion of the fixed blade comb has a thick portion protruding to a side opposite to a side where the movable blade comb is in sliding contact, and
the thick portion has a shape in which an edge is not formed on an outer surface.

6. A hair removal device comprising:
the hair removal device blade according to claim 1 or 2; and
a hair removal device body that holds the hair removal device blade in a state where a distal end of the fixed blade comb and a distal end of the movable blade comb are exposed to outside.

7. The hair removal device according to claim 6, wherein
the hair removal device blade is held on a distal end side of the hair removal device body, and the distal end side of the hair removal device body is curved to a side where the movable blade comb is located with respect to a side where the fixed blade is located.
